(19) United States
(12) Patent Application Publication
(10) Pub. No.: US 2006/0242167 A1
(43) Pub. Date: Oct. 26, 2006

(54) Object based test library for WinFS data model

(75) Inventors: Siddhartha Singh, Sammamish, WA (US); Li Liang, Redmond, WA (US); Zhongwei Wu, Sammamish, WA (US); Tiberiu M. Doman, Redmond, WA (US)

Correspondence Address: WOODCOCK WASHBURN LLP (MICROSOFT CORPORATION), ONE LIBERTY PLACE - 46TH FLOOR, PHILADELPHIA, PA, 19103, US

(73) Assignee: Microsoft Corporation, Redmond, WA (US)

(21) Appl. No.: 11/113,112

(22) Filed: Apr. 22, 2005

(51) Int. Cl. G06F 17/00

(52) U.S. Cl. 707/100

(57) ABSTRACT

A test library for use with a database storage system such as WinFS provides users with a WinFS schema agnostic way to test the WinFS store application programming interfaces (APIs) and to use the WinFS store APIs to populate the WinFS store with randomly generated data. The WinFS test library provides users with an object layer that they can program against to carry out multiple tasks on the WinFS store. Tests can use the WinFS test library to generate schema-agnostic tests that do not break if a schema is changed or removed. For instance, a user can create a WinFS schema and install it in a WinFS store. The WinFS test library will automatically validate that the schema and all of its declared types are properly installed in the store. It will also generate instances of each type, set randomly generated values for every property including nested types, call the store API to create them in the store, and then select values from the store and validate that they were set property. The WinFS test library also automatically validates Update and Delete of the types. The WinFS test library also describes both the store types (metadata) and the store data in the same framework, making it straightforward to write tests on unknown schemas.

### COPYRIGHT NOTICE AND PERMISSION

A portion of the disclosure of this patent document may contain material that is subject to copyright protection. The copyright owner has no objection to the facsimile reproduction by anyone of the patent document or the patent disclosure, as it appears in the Patent and Trademark Office patent files or records, but otherwise reserves all copyright rights whatsoever. The following notice shall apply to this document: Copyright© 2005, Microsoft Corp.

### FIELD OF THE INVENTION

The present invention relates to data storage in a computer system, and more particularly, to systems and methods for creating object based test libraries for use in testing a database store that supports user defined schemas and types.

### BACKGROUND OF THE INVENTION

In accordance with traditional methods to test the WinFS data model and its associated application programming interface (API), a test author would have to write a test that would reference a schema assembly and then create an instance of a UDT (User Defined Type as defined in SQL Server). The author would set the values of the various properties of the UDT, and then invoke one or more WinFS store APIs to insert that UDT into, update that UDT, or delete that UDT from the WinFS store. The author would then write SQL queries to select the UDT from the WinFS store and to verify the changes made by the test. Unfortunately, such a test of the WinFS store would require compile time knowledge of the WinFS types used. To put more types through the same test, the user would have to re-write the same test for the other types. Since there are hundreds of types in the current WinFS store, this would require lots of type specific code. Accordingly, the conventional testing approach leads to code duplication and test code management and maintenance problems as the type definition evolves and new types are added or existing types are removed from the system.

Verification is also a challenge in the conventional testing of the WinFS store, since it has to be hand-crafted, making it susceptible to missing some parts. Verification also requires compile time knowledge of all the properties of a type, and code specific to the type being tested would have to be written. Other types of commonly used verification techniques involve selecting the result once to a file, manually validating the results, then using that file as the golden file, or baseline file, for comparing results from future runs.

Sample code for testing the WinFS data model and for storing APIs using traditional methods is provided below in Example 1.

### Example 1

### Sample Code to Test WinFS Data Model and Store API Using Traditional Methods

```
using System;
using System.Data;
using System.Data.SqlClient;
using System.Data.SqlTypes;
using System.Storage.Store;
using System.Storage.Operations;
using Microsoft.WinFS.Test.BaseTest.Store;
namespace StoreAPISample
{
  class Sample
  {
    [STAThread]
    static void Main(string[] args)
    {
      ConnectionString =
String.Format(“server=np:\\\\{0}\\pipe\\WinFS\\tsql\\query;trusted_connection=yes;
attachdbfilename=\\\\{1}\\DefaultStore”, “.”, System.Environment.MachineName);
      try
      {
        //create an item under root
        SqlCommand createItemCmd = GetCreateItemCommand( );
        //create an store api to insert it
        ExecuteStoreApi(createItemCmd);
        //select the item back from the store
        //validate the properties
      }
      catch(Exception exp)
      {
        Console.WriteLine(exp);
      }
    }
    public static SqlCommand GetCreateItemCommand( )
    {
      SqlCommand sqlCmd = GetCommandForOperation(“CreateItem”);
      RootFolderId = GetRootFolderId( );
      TargetItemId = Guid.NewGuid( );
      newItem = new Folder(TargetItemId);
      newItem.DisplayName = new SqlChars(“New Test Item”);
      param = sqlCmd.Parameters.Add(“@item”, SqlDbType.Udt);
      param.UdtTypeName = “[System.Storage.Store].[Item]”;
      param.Value = newItem;
      param = sqlCmd.Parameters.Add(“@concurrencyToken”, SqlDbType.BigInt);
      param.Direction = ParameterDirection.Output;
      param = sqlCmd.Parameters.Add(“RETURN_VALUE”, SqlDbType.Int);
      param.Direction = ParameterDirection.ReturnValue;
      return sqlCmd;
    }
    public static void ExecuteStoreApi(SqlCommand sqlCmd)
    {
      SqlConnection sqlConn = GetNewSqlConnection( );
      sqlCmd.Connection = sqlConn;
      sqlCmd.Transaction = sqlConn.BeginTransaction( );
      int returnCode = 0;
      try
      {
        sqlCmd.ExecuteNonQuery( );
        sqlCmd.Transaction.Commit( );
        if(sqlCmd.Parameters.Contains(“RETURN_VALUE”) &&
sqlCmd.Parameters[“RETURN_VALUE”].Direction == ParameterDirection.ReturnValue)
        {
          returnCode = (int)sqlCmd.Parameters[“RETURN_VALUE”].Value;
        }
        if(returnCode != 0)
        {
          Console.WriteLine(“Store API {0} returned an error code {1}”,
sqlCmd.CommandText, returnCode);
        }
      }
      finally
      {
        sqlConn.Close( );
      }
    }
    public static Guid GetRootFolderId( )
    {
      string selectQuery = String.Format(“select
[System.Storage.Store].[GetIdForPath](\‘\\\’)”);
      SqlConnection sqlConn = GetNewSqlConnection( );
      SqlCommand sqlCmd = sqlConn.CreateCommand( );
      sqlCmd.CommandText = selectQuery;
      SqlGuid itemId = SqlGuid.Null;
      try
      {
        SqlDataReader sqlReader = sqlCmd.ExecuteReader( );
        if(sqlReader.Read( ))
        {
          itemId = sqlReader.GetSqlGuid(0);
        }
      }
      finally
      {
        sqlConn.Close( );
      }
      return itemId.Value;
    }
    public static SqlCommand GetCommandForOperation(string opName)
    {
      SqlCommand sqlCmd = new SqlCommand( );
      sqlCmd.CommandType = CommandType.StoredProcedure;
      sqlCmd.CommandText = String.Format(“[{0}].{1}”, “System.Storage.Store”, opName);
      return sqlCmd;
    }
    public static SqlConnection GetNewSqlConnection( )
    {
      SqlConnection sqlconn = new SqlConnection(ConnectionString);
      sqlConn.Open( );
      return sqlConn;
    }
    public static string ConnectionString;
    public static Guid TargetItemId;
    public static Guid RootFolderId;
    public static Folder newItem;
  }
}
```

In Example 1, the main method calls the GetCreateItem Command function to create a SQLServer command (SqlCommand) that can then be run to insert an Item into the WinFS Store. The GetCreateItemCommand function creates a new instance of a Folder object, TargetItemId, which is an Item type defined in a schema. It then sets values for some of the properties of the Folder object. In Example 1, the TargetItemId requires knowledge of the Item type defined in the schema as well as properties of the “New Test Item.” Thus, Example 1 requires the test author to have compile time knowledge of the WinFS types used. As will be appreciated by one skilled in the art, a change in the schema may require changes in this code and re-compilation. An addition to the properties of the Folder Item type also will not be picked up by this function. Moreover, to test all the Item types defined in all the WinFS schemas, this function would have to be written for each of the many Types.

Once the GetCreateItemCommand is created in Example 1, the ExecuteStoreApi function is called to actually insert this Folder object into the WinFS Store. The main function in Example 1 does not show it, but more code needs to be added to Example 1 to be able to validate that what was inserted into the WinFS store is what one would expect to find in there when the data is selected back out at a later time. This requirement adds further complication to the testing of the WinFS store.

It is desired to describe both the store types (metadata) as well as the store data in the same framework so that it is straightforward to write tests on unknown schemas so that the test author need not have compile time knowledge of the WinFS types used and may readily verify that the proper information is stored in the WinFS store. The present invention addresses these needs in the art.

### SUMMARY OF THE INVENTION

The WinFS test library of the invention provides users with a technique to test the WinFS store APIs and to use the WinFS store APIs to populate the WinFS store with randomly generated data and without knowledge of the WinFS schema. The WinFS test library of the invention provides users with an object layer (TypeInstance) that they can program against to carry out multiple tasks on the WinFS store. Tests may use the WinFS test library to generate schema-agnostic tests that do not break if a schema is changed or removed. For instance, a user may create a WinFS schema and install it in a WinFS store. The WinFS test library of the invention automatically validates that the schema and all of its declared types are properly installed in the store. The WinFS test library will also generate instances of each type, set randomly generated values for every property including nested types, call the store API to create them in the store, and then select values from the store and validate they were set properly. The WinFS test library will then automatically validate Updates and Deletes of the types in the WinFS store.

In an exemplary embodiment of the invention, a method is provided for testing a data store that stores and manipulates data in accordance with an object oriented programming model, such as WinFS, that provides for the designation of schemas, item types within the schemas, and attributes of the item types, where the attributes have stored values. Such a data store testing method in accordance with the invention comprises:

querying schema types with specific attributes in the data store;

instantiating the schema types with the specific attributes with pre-populated attribute values;

manipulating instances of the schema types; and verifying that the state of the instances of the schema types are as expected based on the manipulation.

In accordance with another exemplary embodiment of the invention, a method is provided for testing such a data store by performing the following steps:

collecting schemas stored in the data store;

for each item type in the collected schemas:
creating instances of the item types,
converting the item type instances into new user defined types (UDTs), and
storing the UDTs in the data store;

assigning values to the attributes of the UDTs at run-time; and

storing the assigned values in the data store.

Such a method may further verify the stored attribute values by retrieving UDT values stored in the data store in the storing step and comparing the retrieved UDT values with values in the item type instances to verify whether or not the values in the item type instances have been stored and retrieved properly.

The scope of the invention also includes computer readable media including software for implementing the methods of the invention. Other features and advantages of the invention may become apparent from the following detailed description of the invention and accompanying drawings.

### BRIEF DESCRIPTION OF THE DRAWINGS

The foregoing summary, as well as the following detailed description of the invention, is better understood when read in conjunction with the appended drawings. For the purpose of illustrating the invention, there is shown in the drawings exemplary embodiments of various aspects of the invention; however, the invention is not limited to the specific methods and instrumentalities disclosed. In the drawings:

FIG. 1 is an exemplary code segment illustrating a managed code class definition for a user defined type;

FIG. 2 is a block diagram illustrating the serialization and deserialization of an instance of a type that has been instantiated in managed code;

FIG. 3 is a diagram illustrating a database table in which an object of a User Defined Type has been persisted;

FIG. 4 is a block diagram illustrating an exemplary storage platform (e.g., WinFS) that may take advantage of the features of the present invention;

FIG. 5 is a diagram illustrating a process for executing a query against persisted objects of a user defined type in the context of the storage platform illustrated in FIG. 4;

FIG. 6 illustrates the WinFS test library schema information class which is an in-memory representation of a WinFS schema;

FIG. 7 illustrates how the Win FS test library of the invention may be used to create an ItemInstance object, which is a representation of an instance of Person.

FIG. 8 illustrates the WinFS test library verifier that verifies that two ItemInstances have the same values for all properties, and hence verifies that the WinFS store APIs work as expected.

FIG. 9 is a block diagram representing an exemplary network environment having a variety of computing devices in which the present invention may be implemented; and

FIG. 10 is a block diagram representing an exemplary computing device in which the present invention may be implemented.

### DETAILED DESCRIPTION OF ILLUSTRATIVE EMBODIMENTS

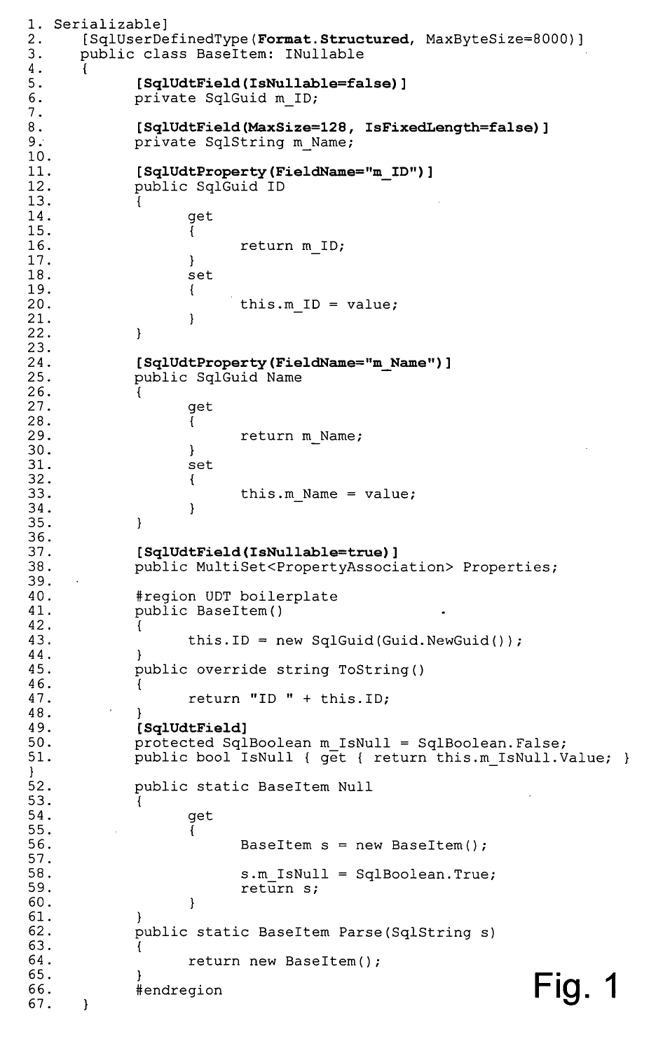

The subject matter of the present invention is described with specificity with respect to FIGS. 1-10 to meet statutory requirements. However, the description itself is not intended to limit the scope of this patent. Rather, the inventors have contemplated that the claimed subject matter might also be embodied in other ways, to include different steps or elements similar to the ones described in this document, in conjunction with other present or future technologies. Moreover, although the term “step” may be used herein to connote different aspects of methods employed, the term should not be interpreted as implying any particular order among or between various steps herein disclosed unless and except when the order of individual steps is explicitly described.

Overview

A WinFS test library in accordance with the invention provides users with a way, independent of WinFS schema, to test the WinFS store application programming interfaces (APIs) and to use the WinFS store APIs to populate the WinFS store with randomly generated data. The WinFS test library provides users with an object layer that they can program against to carry out multiple tasks on the WinFS store. Tests can use the WinFS test library to generate schema-agnostic tests that do not break if a schema is changed or removed. For instance, a user can create a WinFS schema and install it in a WinFS store. The WinFS test library will automatically validate that the schema and all of its declared types are properly installed in the store. It will also generate instances of each type, set randomly generated values for every property including nested types, call the store API to create them in the store, and then select values from the store and validate that they were set property. The WinFS test library also automatically validates Updates and Deletes of the types. The WinFS test library also describes both the store types (metadata) and the store data in the same framework, making it straightforward to write tests on unknown schemas.

Prior to providing a detailed description of the WinFS test library in accordance with the invention, an overview of WinFS will be provided. This description is provided to put the present invention in the context of an exemplary embodiment and is not intended to limit the invention to the particular embodiment (WinFS) described herein. Those skilled in the art will appreciate that the invention may be used in connection with other storage platforms as appropriate.

WinFS

Microsoft SQL SERVER is a comprehensive database management platform that provides extensive management and development tools, a powerful extraction, transformation and loading (ETL) tool, business intelligence and analysis services, and other capabilities. The SQL SERVER database supports the Microsoft Windows .NET Framework Common Language Runtime (CLR) and SQL SERVER also supports User Defined Types (UDTs) that are created with managed code in the CLR environment and persisted in the SQL SERVER database store. UDTs enable a developer to extend the scalar type system of the database and provide two key benefits from an application architecture perspective: they provide strong encapsulation (both in the client and the server) between the internal state and the external behaviors and they provide deep integration with other related server features. Once a UDT is defined, it can be used in all the contexts that a system type can be used in SQL SERVER, including in column definitions, variables, parameters, function results, cursors, triggers, and replication.

The process of defining a UDT on a database server is accomplished as follows:
a) create a class in managed code that follows the rules for UDT creation;
b) load the Assembly that contains the UDT into a database on the server using the CREATE ASSEMBLY statement; and
c) create a type in the database using the CREATE TYPE statement that exposes the managed code UDT.
   At this point, the UDT can be used in a table definition.

When a UDT definition is created in managed code, the type must meet the following requirements:
a) it must be marked as Serializable;
b) it must be decorated with the SqlUserDefinedTypeAttribute;
c) the type should be NULL aware by implementing the INullable interface;
d) the type must have a public constructor that takes no arguments; and
e) the type should support conversion to and from a string by implementing the following methods:
   1. Public String ToString( ); and
   2. Public Shared <type> Parse (SqlString s).

Co-pending, commonly assigned, U.S. patent application Ser. No. 10/692,225, entitled “System And Method For Object Persistence In A Database Store,” which is hereby incorporated by reference in its entirety, describes another feature of UDTs in which the fields and behaviors of a CLR class definition for a UDT are annotated with storage attributes that describe a layout structure for instances of the UDT in the database store. Specifically, each field of a CLR class that defines a UDT is annotated with a storage attribute that controls the storage facets of the type, such as size, precision, scale, etc. In one embodiment, this is achieved by annotating each field with a custom storage attribute named SqlUdtField( ). This attribute annotates fields with additional storage directives. These directives are enforced when the object is serialized to disk. In addition, every managed behavior (e.g., a method that can be invoked on the UDT object, for example, to return the value of a field) defined in the CLR class is annotated with an attribute that denotes an equivalent structural access path for that managed behavior. In one embodiment, the custom attribute used for this purpose is named SqlUdtProperty( ), and the database server (e.g., SQL SERVER) assumes that the implementation of properties annotated with this custom attribute will delegate to a field specified as part of the attribute definition. This lets the server optimize access to the property structurally without creating an instance and invoking the behavior on it.

FIG. 1 is an exemplary code listing of a CLR class that defines a UDT. As shown, the CLR class has been annotated with the SqlUdtField( ) and SqlUdtProperty( ) custom attributes as described above. Specifically, the SqlUdtField( ) custom attribute has been added at lines 5, 8, 37, and 49 to annotate the respective fields of the exemplary UDT class definition. The SqlUdtProperty( ) custom attribute has been added at lines 11 and 24 to annotate the respective managed behaviors of the class.

The CLR class that defines the UDT is then compiled into a dynamic link library (dll). An Assembly containing the compiled class may then be created using the following T-SQL script commands:

create assembly test

from ‘c:\test.dll’

go

The following T-SQL script commands may then be used to create the UDT on the server:

create type BaseItem

external name [test]: [BaseItem]

go

Once the UDT has been created on the server, a table (e.g., “MyTable”) can be created defining an attribute of the table as the UDT type, as follows:

create table MyTable
(

Item BaseItem,
ItemId as item::ID

)
go

declare @i BaseItem
set @i = convert(BaseItem, ″)
insert into MyTable values (@i)
go

The UDT expression can then be used in a query such as: SELECT Item.ID, Item.Name FROM MyTable.

With the integration of the CLR into SQL SERVER and the ability to define UDTs from a class definition in managed code, applications can now instantiate objects of the type defined by the managed code class and have those objects persisted in the relational database store as a UDT. Moreover, the class that defines the UDT can also include methods that implement specific behaviors on objects of that type. An application can therefore instantiate objects of a type defined as a UDT and can invoke managed behaviors over them.

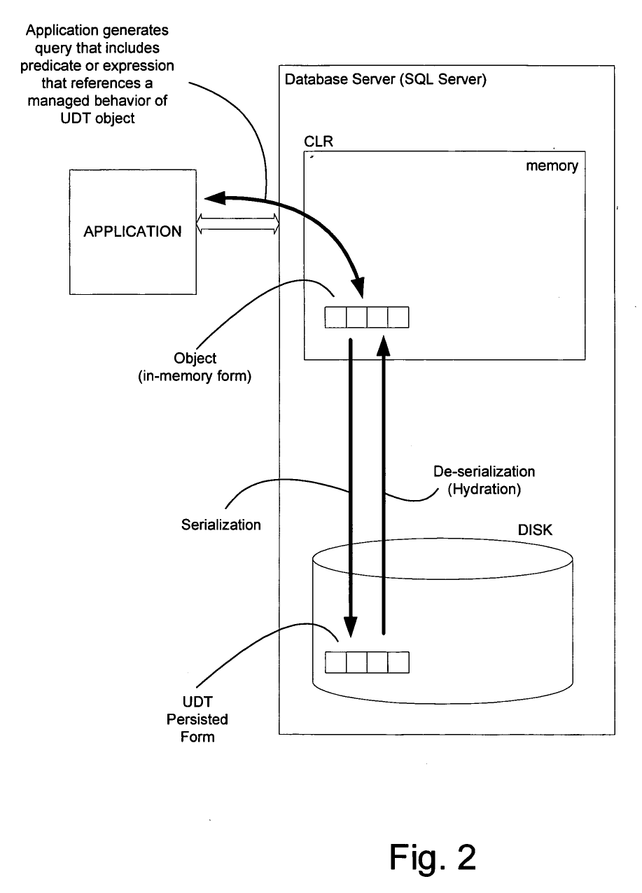

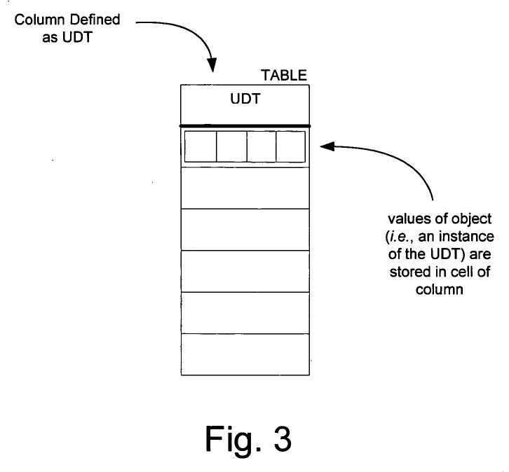

When an object of a class that has been defined as a UDT is instantiated in the CLR, the object can be persisted in the database store through the process of object serialization, wherein the values of the variables of the class are transferred to physical storage (e.g., hard disk). FIG. 2 illustrates the serialization of an object in memory to its persisted form on disk. The object may be persisted in the database store in a traditional relational database table of the format illustrated in FIG. 3. As shown, the table comprises a column of the specified UDT. The serialized values of a persisted object of the specified UDT occupy a cell of the UDT column.

As shown in FIG. 2, when an application generates a query that includes a predicate or an expression that references a managed behavior of a UDT object that has been persisted in the database store (e.g., a behavior that returns the value of a field of the UDT object), the persisted object must be de-serialized (sometimes also referred to as “hydrating”) and the CLR must allocate memory for the full object in order to receive its stored values. The CLR must then invoke the actual method (i.e., behavior) of the UDT class that returns the value(s) that is the subject of the query. As described in the aforementioned U.S. patent application Ser. No. 10/692,225, the SqlUdtField( ) and SqlUdtProperty( ) annotations in the CLR class definition of a UDT can be used by the database server to also allow direct structural access to the values of certain UDT fields without the need for object hydration.

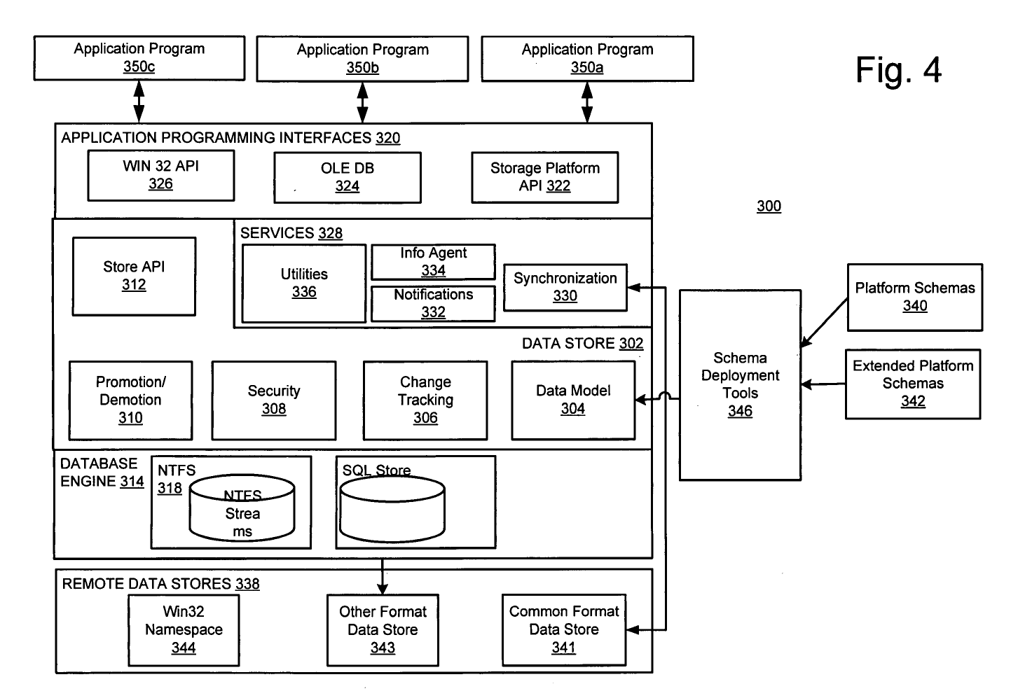

WinFS is a storage platform that takes advantage of the CLR integration and the provision of UDTs in SQL SERVER. WinFS is described in commonly assigned patent application Ser. No. 10/646,646, filed Aug. 21, 2003, entitled “Storage Platform For Organizing, Searching, And Sharing Data,” the disclosure of which is hereby incorporated by reference in its entirety. FIG. 4 is a block diagram illustrating the architecture of the WinFS storage platform 300. As shown in FIG. 4, the storage platform 300 comprises a data store 302 implemented on a database engine 314. In one embodiment, the database engine 314 comprises a relational database engine, such as the Microsoft SQL SERVER relational database engine.

The data store 302 implements a data model 304 that supports the organization, searching, sharing, synchronization, and security of data in the form of Items and relationships between Items. Specific types of Items are described in schemas, such as schemas 340, and the storage platform 300 provides tools 346 for deploying those schemas as well as for extending those schemas as extended platform schemas 342.

A change tracking mechanism 306 implemented within the data store 302 provides the ability to track changes to the data store 302. The data store 302 also provides security capabilities 308 and a promotion/demotion capability 310. The data store 302 also provides a set of store application programming interfaces 312 to expose the capabilities of the data store 302 to other storage platform components and application programs (e.g., application programs 350a, 350b, and 350c) that utilize the storage platform 300.

The storage platform 300 further comprises a storage platform application programming interface (API) 322, which enables application programs, such as application programs 350a, 350b, and 350c, to access the capabilities of the storage platform 300 and to access the data stored in the database. The storage platform API 322 may be used by application programs in combination with other APIs, such as the OLE DB API 324 and the Microsoft WINDOWS Win32 API 326.

The storage platform 300 may also provide a variety of services 328 to application programs, including a synchronization service 330 that facilitates the sharing of data among users or systems. For example, the synchronization service 330 may enable interoperability with remote data stores 338 including other data stores 341 having the same format as data store 302, as well as access to data stores 343 having other formats. The storage platform 300 also provides file system capabilities that allow interoperability of the data store 302 with remote data stores 338 such as Win32 Namespace 344 as well as existing file systems, such as the WINDOWS NTFS files system 318.

In at least some embodiments, the storage platform 300 may also provide application programs with additional capabilities for enabling data to be acted upon and for enabling interaction with other systems. These capabilities may be embodied in the form of additional services 328, such as an Info Agent service 334 and a notification service 332, as well as in the form of other utilities 336.

In at least some embodiments, the storage platform 300 is embodied in, or forms an integral part of, the hardware/software interface system of a computer system. For example, and without limitation, the storage platform 300 may be embodied in, or form an integral part of, an operating system, a virtual machine manager (VMM), a Common Language Runtime (CLR) or its functional equivalent, or a Java Virtual Machine (JVM) or its functional equivalent.

Through its common storage foundation, and schematized data, the storage platform 300 enables more efficient application development for consumers, knowledge workers and enterprises. It offers a rich and extensible programming surface area that not only makes available the capabilities inherent in its data model, but also embraces and extends existing file system and database access methods.

In the following description, and in various ones of the figures, the storage platform 300 is referred to as “WinFS.” However, use of this name to refer to the storage platform is solely for convenience of description and is not intended to be limiting in any way.

The data model of the WinFS platform defines units of data storage in terms of Items, Item extensions, and Relationships. An “Item” is the fundamental unit of storage information. The data model provides a mechanism for declaring Items and Item extensions and for establishing relationships between Items. Items are the units that can be stored and retrieved using operations such as copy, delete, move, open, and so forth. Items are intended to represent real-world and readily-understandable units of data like Contacts, People, Services, Locations, Documents (of all various sorts), and so on. Item extensions are a way to extend the definition of an existing Item, and Relationships are a defined link between Items.

In WinFS, different Item types are defined for storing information. For example, Item types are defined for Contacts, People, Locations, Documents, etc. Each Item type is described by a schema that defines the properties and characteristics of a given Item. For example, a “Location” Item may be defined as having properties such as EAddresses, MetropolitanRegion, Neighborhood, and PostalAddresses. Once a schema is defined for a given Item type, deployment tools are used to translate the schema into a corresponding CLR class definition for that Item type, and then a UDT is created in the database store from the CLR class definition (in the manner described above) in order for instances of the WinFS Item type to be persisted in the database store. Using the WinFS API 322, applications (e.g., applications 350a, 350b, 350c, etc.) can create instances of the Item types supported by the data store in order to store and retrieve information from the storage platform data store. Each instance of an Item type stored in the data store has a unique identifier (e.g., Item_ID) associated with it; in one embodiment, each Item identifier is a globally unique identifier, i.e. “guid.” Thus, the WinFS platform leverages the CLR integration and UDT capabilities of the database store to provide a platform for storing Items of information.

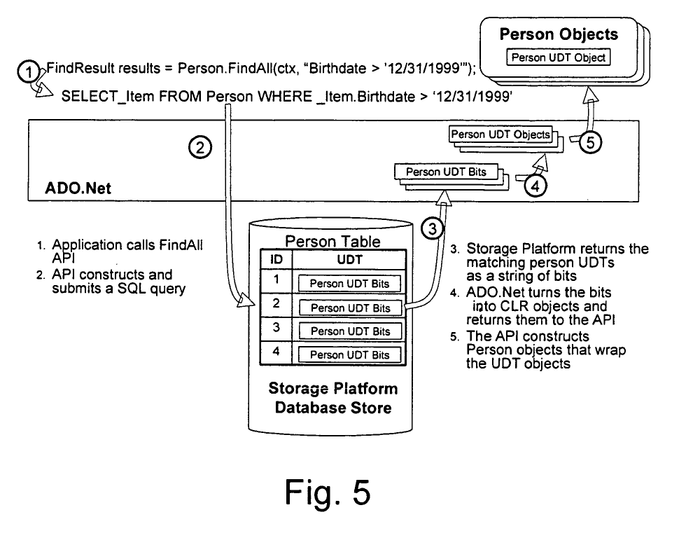

As with any instance of a UDT in SQL SERVER, instances of WinFS Items are ultimately stored in tables of the database store in the manner illustrated in FIG. 3. Applications can then submit queries to the WinFS platform to search for and retrieve Items from the data store that satisfy the search criteria. FIG. 5 illustrates how a query is executed against the data store to retrieve instances of an Item type called “Person.” In step (1), an application uses a “FindAll” method of the WinFS API 322 to initiate a query for all Items that satisfy a particular search criteria—in this case, all instances of the Person type in which the value in a “Birthday” field of the type is greater than a particular date (e.g., Dec. 31, 1999). At step (2), the WinFS API 322 translates the “FindALL” operation into a SQL query and submits it to the underlying database engine, e.g., SQL SERVER. In step (3), the database engine executes the query against the corresponding instances of the Person UDT and returns the stored values for each matching instance of the Person UDT. In this example, at step (4), ADO.Net turns the bits returned from the database store into CLR objects (i.e., the process of object hydration discussed above) and returns them to the WinFS API 322. ADO.Net is a component of the Microsoft .NET Framework that provides managed code access via the CLR to data sources such as SQL SERVER. The WinFS API then wraps the Person UDT objects and returns them to the application as Items of the Person type.

As explained below, the present invention provides a test library for testing such a storage platform without necessarily understanding the schemas implemented in the storage platform.

WinFS Test Library (wfstlib)

The WinFS test library of the invention provides an object oriented programming model that enumerates all WinFS schema types using a TypeInstance (also used interchangeably herein as “ItemInstance”) that provides an object hierarchy for XML schema. The TypeInstance allows the user to discover and query WinFS schema types with specific attributes and to instantiate Types with pre-populated random values. TypeInstance is also used to manipulate instances of Types by setting/getting property values and keeping track of the changes to those properties. TypeInstance is also used to insert into, update and delete these instances from the WinFS store. A Verifier generated at runtime verifies that the state of these instances in the WinFS store is as expected in the WinFS data model specification.

As will be explained below, TypeInstance is a specific class in the WinFS test library of the invention. TypeInstance provides a schema-agnostic representation of an instance of a WinFS type and populates and manipulates property values at run-time, not compile time. TypeInstance also encapsulates not only the WinFS store UDT but also other state data that is persisted with the UDT and has a representation of a tombstoned entity. TypeInstance further keeps track of changes made to an instance after it has been inserted into or updated in the WinFS store, without compile time knowledge of the encapsulated UDT's property names, types or values.

For example, a UDT representing an Item in a WinFS store is created, updated and deleted using an API (FIG. 4) that creates the Item and a link to the Item and updates/deletes the Item and its link. The API also may install a new schema into the WinFS store. For example, to create a new UDT for a new “Contact” (CreateItem(New Contact)) in a WinFS store, an XML schema is created as follows:

```
<Schema name = “my schema”>
    <ItemType Name = “contact”>
        <Property Name = “full name”>
            <Type = string>
```

At compile time, a new entry in the dynamic link library (DLL) is created as “myschema.dll.” All XML schema for the TypeInstance are designed to follow this object hierarchy so that schema name, Type, and properties have predefined characteristics and locations in the schema. This enables the schema names, Types, and properties to be grouped across schemas by creating a “schema collection” object of the instances of the Type defined in the schema (e.g., instances of Contacts). The user may also program against known Property Names to assign random values to the property types in the schema. Thus, in this example, the user may collect across all schemas in the WinFS store and create instances of each ItemType having randomly assigned values. The actual table values in the Contacts, for example, do not fill in until run-time, at which time the values are filled in from the schema collection.

The verifier of the invention is generated at runtime and verifies the complete UDT graph and other entity states that are encapsulated in TypeInstance. In other words, the value in TypeInstance is compared against the UDT value in the WinFS data store of Type Contact to verify that the value was properly entered into the WinFS data store.

In accordance with the invention, a builder utility (BuilderUtil) also may be provided to propagate changes made to a TypeInstance object to the WinFS data store by generating the appropriate T-SQL or SqlClient code and calling the required store API with the appropriate parameters.

As noted above, a schema collection function, WinFSSchemaCollection, is also called to perform WinFSSchema collection so that the schemas can be updated dynamically as schemas are added to the store (or just as assemblies are created). This enables changes to be made to the WinFSSchemas and their values without changing the test code. The collected WinFSSchema contains metadata information for all installed schemas and offers a way to query the WinFS metadata and to generate type instances for WinFS types. Also, because the WinFS schema collection code loads schema metadata directly from the assembly, it offers a simple way to validate/use schemas without installing them in the store.

A function SchemaBuilder also may be used as a tool to create a schema assembly and install it in the store. SchemaBuilder uses a schema XML as a starting point. The test library provides a lightweight framework for generating schema XMLs. SchemaBuilder, in turn, uses WinFSSchemaCollection to validate the correct installation of schemas. As part of the test library, SchemaBuilder offers a framework for end-to-end type creation and use.

Those skilled in the art will appreciate that a WinFS schema is a collection of WinFS type definitions grouped in a WinFS namespace and evolving together. They constitute a unit of WinFS store information describing all the related types used by a WinFS application or test library. Since they are all changing together from one WinFS version to another, the Types in a schema are strongly connected. The schema also contains auxiliary information used by the WinFS store to improve performance or by applications to save and restore data. For example, a WinFS schema for describing email contacts might appear as follows:

```
<Schema Version=“0.1.0” Alias=“Contacts” Namespace=“Company.Contacts” >
    <InlineType Name=“FullName” BaseType=“WinFS.InlineType” >
        <Property Name=“DisplayAs” Type=“WinFS.String” Size=“255”/>
        <Property Name=“GivenName” Type=“WinFS.String” Size=“64” />
        <Property Name=“MiddleName” Type=“WinFS.String” Size=“64” />
        <Property Name=“Nickname” Type=“WinFS.String” Size=“64” />
    </InlineType>
    <Enumeration Name=“Gender” >
        <EnumerationMember Name=“Unknown” />
        <EnumerationMember Name=“Male” />
        <EnumerationMember Name=“Female” />
    </Enumeration>
    <EntityType Name=“Contact” BaseType=“WinFS.Item” >
            <Property Name=“EAddresses” Type=“Array(Core.EAddress)” />
            <Property Name=“PostalAddresses” Type=“Array(Core.PostalAddress)”
/>
            <Property Name=“Notes” Type=“Array(Core.RichText)” />
    </EntityType>
    <EntityType Name=“Person” BaseType=“Contacts.Contact” >
            <Property Name=“BirthDate” Type=“WinFS.DateTime” />
            <Property Name=“Gender” Type=“Contacts.Gender” />
            <Property Name=“Names” Type=“Array(Contacts.FullName)” />
            <Property Name=“Profession” Type=“Array(Core.Keyword)” />
    </EntityType>
</Schema>
```

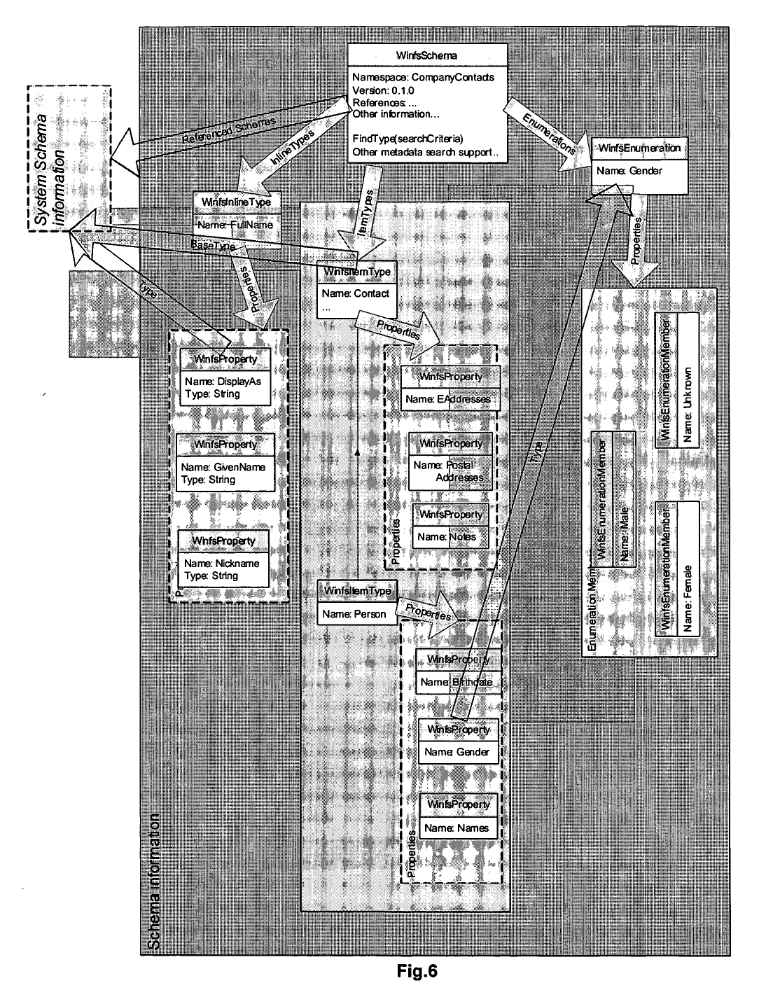

For the WinFS schema used in connection with the WinFS data store, the WinFS test library of the invention will create an object hierarchy to describe the schema information (metadata) as shown in FIG. 6. FIG. 6 illustrates the WinFS test library schema information class which is an in-memory representation of a WinFS schema. In FIG. 6, the WinfsSchema class is shown at the top, which contains a collection of different types declared by that schema. In FIG. 6, the WinfsSchema object contains all the attributes and type information from the schema XML hierarchy. It also offers support for finding a specific type or enumeration defined in the schema using the local name or the type identifier and for mapping a name to the store name of the schema.

As illustrated in FIG. 6, the WinfsInlineType and WinfsItemType and other objects contain information on the respective types (name, what type they are derived from and what types inherit from them) and offer support for operations such as finding a specific property in the current type or in the current type and all its parents, mapping a local type name to the full (globally unique) type name, mapping the store type to its corresponding managed type so object oriented managed to store operations can be performed, determining the constraints the properties satisfy in the Type and/or in the parent Types, and listing all the Types that derive from the current Type. As illustrated, other objects are created to offer support for different auxiliary structures in the schema (enumerations, associations etc.).

As further illustrated in FIG. 6, the WinfsEnumeration and WinfsEnumerationMember objects store information about the enumeration types defined in the WinFS schema. These objects offer the ability to map between the name of the element (as it is listed in the XML) to the identifier of the element (as it is saved in the WinFS store) and they can retrieve the full name of the enumeration.

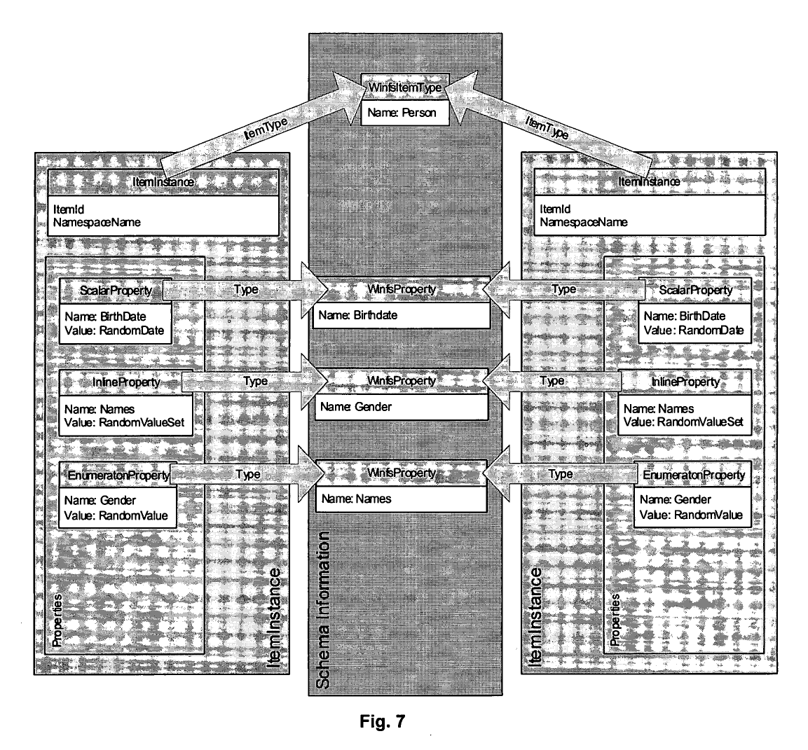

The WinFS test library of the invention then uses the schema information object (WinfsSchema) illustrated in FIG. 6 to create a representation of instances of schema types. For example, as shown in FIG. 7, the WinFS test library may be used to create an ItemInstance object that is a representation of an instance of Person. FIG. 7 illustrates two ItemInstance objects, one on the left and one on the right. In the center of FIG. 7 is the WinFSSchema type (WinfsItemType) that these ItemInstance objects are instances of. The property values inside the ItemInstance are a value that the WinfsType for this property allows. The arrows with the text “ItemType” represents the fact that the ItemInstance is an instance of the ItemType “Person”. Each ItemInstance has a collection of properties, shown in the box marked “Properties”. The arrow marked “Type” represents the fact that each property is an instance of the WinfsProperty objects defined in the WinFS Schema.

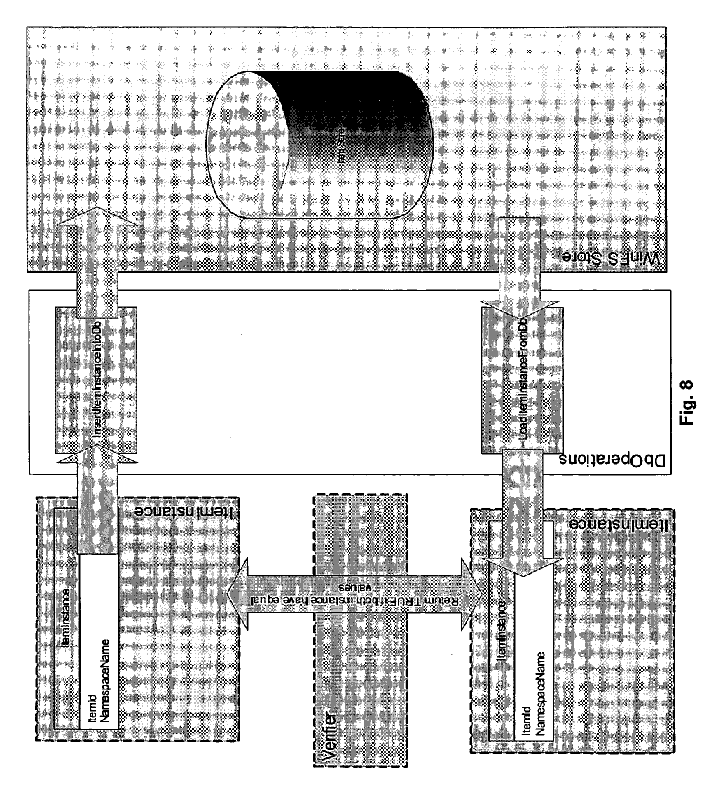

FIG. 8 shows how the Verifier and DbOperations interact with the ItemInstance objects (FIG. 7) and the WinFS Store. FIG. 8 also illustrates the WinFS test library verifier that verifies that two ItemInstances have the same values for all properties, and hence verifies that the WinFS store APIs work as expected. In FIG. 8, the WinFS test library verifier uses WinFS test library DbOperations to insert an ItemInstance into the WinFS store as an item, and also loads an ItemInstance from an item in WinfsStore. The WinFS test library can then compare the two ItemInstance objects to verify that all the properties they contain have identical values. WinFS test library DbOperations can convert an ItemInstance to the item format that a WinFS store understands and stores, and can also convert an item to an ItemInstance object.

On the top left of FIG. 8 is illustrated an ItemInstance object. In the center is the DbOperations object. DbOperations takes an ItemInstance object, converts it into a Item object and stores it in the WinFS Store (shown in the right of the figure) using the WinFS Store API. This process of taking an ItemInstance object and persisting it to the WinFS Store is shown at the top with the arrows representing the direction of flow of data from the Test Library to the WinFS Store. “InsertItemInstanceIntoDb” is the specific function in the DbOperations object that carries out this insertion. The other function, “LoadltemInstanceFromDb”, shown at the bottom, takes an Item object from the WinFS Store and converts it back into an ItemInstance object, resulting in the object represented by the block in the bottom left of the figure. Then, given two ItemInstance objects (top left and bottom left in FIG. 8) representing the same Item object in the WinFS data store, the Verifier object (left, center in FIG. 8) compares values in the two ItemInstance objects and verifies if they are all equal. Thus, the Verifier object verifies the expected behavior of the WinFS Store API.

Example 2 is an example of a test that uses the WinFS test library of the invention as just described with respect to FIGS. 6-8.

### Example 2

### Sample Code to test WinFS Data Model and Store API

```
using System;
using System.Data;
using System.Data.SqlClient;
using System.Data.SqlTypes;
using System.Storage.Store;
using System.Storage.Operations;
namespace Sample
{
  public class InsertSampleTestGroup : TestGroup
  {
    public void Insert_Delete_Item( )
    {
      SchemaColl = WinfsSchemaCollection.GetSchemaCollectionSingleton( );
      //construct DbOperations
      DbOperations DbOperations = new DbOperations(String.Format(“\\\\{0}\\DefaultStore”,
System.Environment.MachineName));
      Verifier Verifier = new Verifier(DbOperations);
      //create a test root folder
      ItemInstance TestRootFolder = CreateTestRootFolder(DbOperations);
      //loop through all the schemas in the schema collection
      foreach(WinfsSchema schema in SchemaColl.Schemas)
      {
        //loop through all the item types in the test schema
        foreach(WinfsItemType itemType in schema.ItemTypes)
        {
          //create an instance of this item type
          ItemInstance itemIns = new ItemInstance(itemType, TestRootFolder.ItemId);
          Verifier.VerifyItemNotInDb(itemIns);
          //insert it into the db
          DbOperations.InsertItemIntoDb(itemIns);
          //verify
          Verifier.VerifyItemInDb(itemIns);
          //delete the item from db
          DbOperations.DeleteItemFromDb(itemIns.ItemId);
          //verify
          Verifier.VerifyItemDeleted(itemIns);
        }
      }
    }
    private ItemInstance CreateTestRootFolder(DbOperations DbOperations)
    {
      //get the itemid of the root
      Guid rootFolderGuid = DbOperations.GetIdForPath(“\\”).Value;
      //create the test folder
      WinfsItemType folderType = SchemaColl.GetWinfsItemType(“System.Storage.Folder”);
      ItemInstance testRootFolder = new ItemInstance(folderType, rootFolderGuid);
      //insert into db
      DbOperations.InsertItemIntoDb(testRootFolder);
      return testRootFolder;
    }
    private WinfsSchemaCollection SchemaColl;
  }
}
```

Example 2 is a code sample that exhibits how one would achieve the same goals using the test library of the invention instead of using traditional methods as described above with respect to Example 1. In Example 2, the Insert_Delete_Item function does all the work. It creates the DbOperations and Verifier objects discussed above and shown in FIG. 8. Using the SchemaCollection object it then creates instances of ItemInstance objects, one for each Item type defined in all the WinFS Schemas. For each ItemInstance it creates, it inserts them into the store using the DbOperations object, and verifies they were inserted as expected using the Verifier object. This code also shows that the Verifier object can also verify other WinFS Store API calls, for example, if an Item was deleted as expected.

The program illustrated in Example 2 requires no compile time dependency on the WinFS Schemas. All the information is collected at run-time; therefore, any changes in WinFS Schemas are picked up at run-time. In example 2, a test group is inserted as a WinFS “public class.” A schema collection is initialized to create relationships among the schema. The system then loops through all the schemas in the schema collection and all the item types in the test schema to create an instance of the item Type having random property values in accordance with the invention.

Though the invention is described in the context of XML schemas for the WinFS data store available from Microsoft Corporation, those skilled in the art will appreciate that many other schemas and data stores may be used to implement the techniques of the invention. Accordingly, the invention is not intended to be limited to the particular embodiments described herein.

Exemplary Computer Environment

As is apparent from the above, all or portions of the various systems, methods, and aspects of the present invention may be embodied in hardware, software, or a combination of both. When embodied in software, the methods and apparatus of the present invention, or certain aspects or portions thereof, may be embodied in the form of program code (i.e., instructions). This program code may be stored on a computer-readable medium, such as a magnetic, electrical, or optical storage medium, including without limitation a floppy diskette, CD-ROM, CD-RW, DVD-ROM, DVD-RAM, magnetic tape, flash memory, hard disk drive, or any other machine-readable storage medium, wherein, when the program code is loaded into and executed by a machine, such as a computer or server, the machine becomes an apparatus for practicing the invention. A computer on which the program code executes will generally include a processor, a storage medium readable by the processor (including volatile and non-volatile memory and/or storage elements), at least one input device, and at least one output device. The program code may be implemented in a high level procedural or object oriented programming language. Alternatively, the program code can be implemented in an assembly or machine language. In any case, the language may be a compiled or interpreted language.

The present invention may also be embodied in the form of program code that is transmitted over some transmission medium, such as over electrical wiring or cabling, through fiber optics, over a network, including a local area network, a wide area network, the Internet or an intranet, or via any other form of transmission, wherein, when the program code is received and loaded into and executed by a machine, such as a computer, the machine becomes an apparatus for practicing the invention.

When implemented on a general-purpose processor, the program code may combine with the processor to provide a unique apparatus that operates analogously to specific logic circuits.

Moreover, the invention can be implemented in connection with any computer or other client or server device, which can be deployed as part of a computer network, or in a distributed computing environment. In this regard, the present invention pertains to any computer system or environment having any number of memory or storage units, and any number of applications and processes occurring across any number of storage units or volumes, which may be used in connection with processes for persisting objects in a database store in accordance with the present invention. The present invention may apply to an environment with server computers and client computers deployed in a network environment or distributed computing environment, having remote or local storage. The present invention may also be applied to standalone computing devices, having programming language functionality, interpretation and execution capabilities for generating, receiving and transmitting information in connection with remote or local services.

Distributed computing facilitates sharing of computer resources and services by exchange between computing devices and systems. These resources and services include, but are not limited to, the exchange of information, cache storage, and disk storage for files. Distributed computing takes advantage of network connectivity, allowing clients to leverage their collective power to benefit the entire enterprise. In this regard, a variety of devices may have applications, objects or resources that may implicate processing performed in connection with the object persistence methods of the present invention.

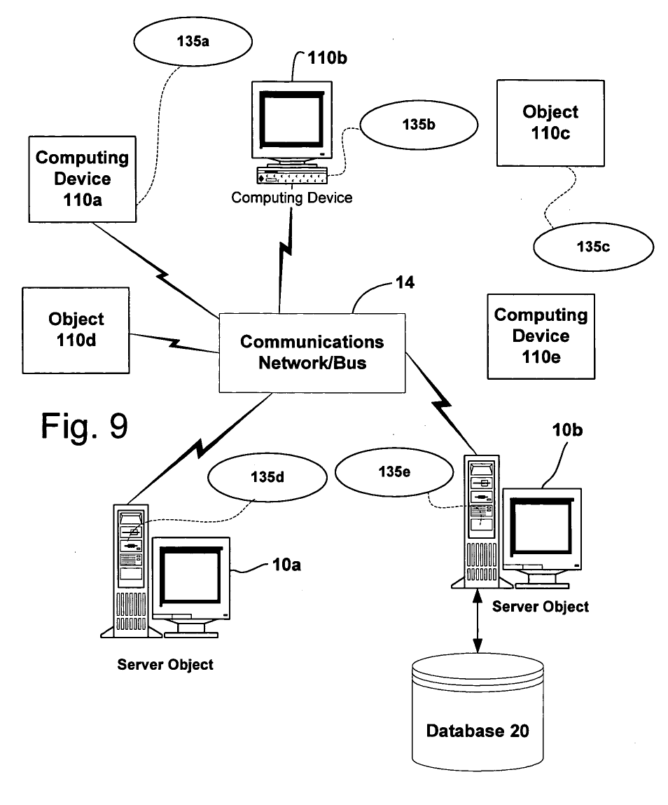

FIG. 9 provides a schematic diagram of an exemplary networked or distributed computing environment. The distributed computing environment comprises computing objects 10a, 10b, etc. and computing objects or devices 110a, 110b, 110c, etc. These objects may comprise programs, methods, data stores, programmable logic, etc. The objects may comprise portions of the same or different devices such as PDAs, televisions, MP3 players, personal computers, etc. Each object can communicate with another object by way of the communications network 14. This network may itself comprise other computing objects and computing devices that provide services to the system of FIG. 9, and may itself represent multiple interconnected networks. In accordance with an aspect of the invention, each object 10a, 10b, etc. or 110a, 110b, 110c, etc. may contain an application that might make use of an API, or other object, software, firmware and/or hardware, to request use of the processes used to implement the object persistence methods of the present invention.

It can also be appreciated that an object, such as 110c, may be hosted on another computing device 10a, 10b, etc. or 110a, 110b, etc. Thus, although the physical environment depicted may show the connected devices as computers, such illustration is merely exemplary and the physical environment may alternatively be depicted or described comprising various digital devices such as PDAs, televisions, MP3 players, etc., software objects such as interfaces, COM objects and the like.

There are a variety of systems, components, and network configurations that support distributed computing environments. For example, computing systems may be connected together by wired or wireless systems, by local networks or widely distributed networks. Currently, many of the networks are coupled to the Internet, which provides the infrastructure for widely distributed computing and encompasses many different networks. Any of the infrastructures may be used for exemplary communications made incident to the present invention.

The Internet commonly refers to the collection of networks and gateways that utilize the TCP/IP suite of protocols, which are well-known in the art of computer networking. TCP/IP is an acronym for “Transmission Control Protocol/Internet Protocol.” The Internet can be described as a system of geographically distributed remote computer networks interconnected by computers executing networking protocols that allow users to interact and share information over the network(s). Because of such wide-spread information sharing, remote networks such as the Internet have thus far generally evolved into an open system for which developers can design software applications for performing specialized operations or services, essentially without restriction.

Thus, the network infrastructure enables a host of network topologies such as client/server, peer-to-peer, or hybrid architectures. The “client” is a member of a class or group that uses the services of another class or group to which it is not related. Thus, in computing, a client is a process, i.e., roughly a set of instructions or tasks, that requests a service provided by another program. The client process utilizes the requested service without having to “know” any working details about the other program or the service itself. In a client/server architecture, particularly a networked system, a client is usually a computer that accesses shared network resources provided by another computer, e.g., a server. In the example of FIG. 9, computers 110a, 110b, etc. can be thought of as clients and computer 10a, 10b, etc. can be thought of as servers, although any computer could be considered a client, a server, or both, depending on the circumstances. Any of these computing devices may be processing data in a manner that implicates the object persistence techniques of the invention.

A server is typically a remote computer system accessible over a remote or local network, such as the Internet. The client process may be active in a first computer system, and the server process may be active in a second computer system, communicating with one another over a communications medium, thus providing distributed functionality and allowing multiple clients to take advantage of the information-gathering capabilities of the server. Any software objects utilized pursuant to the persistence mechanism of the invention may be distributed across multiple computing devices.

Client(s) and server(s) may communicate with one another utilizing the functionality provided by a protocol layer. For example, HyperText Transfer Protocol (HTTP) is a common protocol that is used in conjunction with the World Wide Web (WWW), or “the Web.” Typically, a computer network address such as an Internet Protocol (IP) address or other reference such as a Universal Resource Locator (URL) can be used to identify the server or client computers to each other. The network address can be referred to as a URL address. Communication can be provided over any available communications medium.

Thus, FIG. 9 illustrates an exemplary networked or distributed environment, with a server in communication with client computers via a network/bus, in which the present invention may be employed. The network/bus 14 may be a LAN, WAN, intranet, the Internet, or some other network medium, with a number of client or remote computing devices 110a, 110b, 110c, 110d, 110e, etc., such as a portable computer, handheld computer, thin client, networked appliance, or other device, such as a VCR, TV, oven, light, heater and the like in accordance with the present invention. It is thus contemplated that the present invention may apply to any computing device in connection with which it is desirable to maintain a persisted object.

In a network environment in which the communications network/bus 14 is the Internet, for example, the servers 10a, 10b, etc. can be servers with which the clients 110a, 110b, 110c, 110d, 110e, etc. communicate via any of a number of known protocols such as HTTP. Servers 10a, 10b, etc. may also serve as clients 110a, 110b, 110c, 110d, 110e, etc., as may be characteristic of a distributed computing environment.

Communications may be wired or wireless, where appropriate. Client devices 110a, 110b, 110c, 110d, 110e, etc. may or may not communicate via communications network/bus 14, and may have independent communications associated therewith. For example, in the case of a TV or VCR, there may or may not be a networked aspect to the control thereof. Each client computer 110a, 110b, 110c, 110d, 110e, etc. and server computer 10a, 10b, etc. may be equipped with various application program modules or objects 135 and with connections or access to various types of storage elements or objects, across which files or data streams may be stored or to which portion(s) of files or data streams may be downloaded, transmitted or migrated. Any computer 10a, 10b, 110a, 110b, etc. may be responsible for the maintenance and updating of a database, memory, or other storage element 20 for storing data processed according to the invention. Thus, the present invention can be utilized in a computer network environment having client computers 110a, 110b, etc. that can access and interact with a computer network/bus 14 and server computers 10a, 10b, etc. that may interact with client computers 110a, 110b, etc. and other like devices, and databases 20.

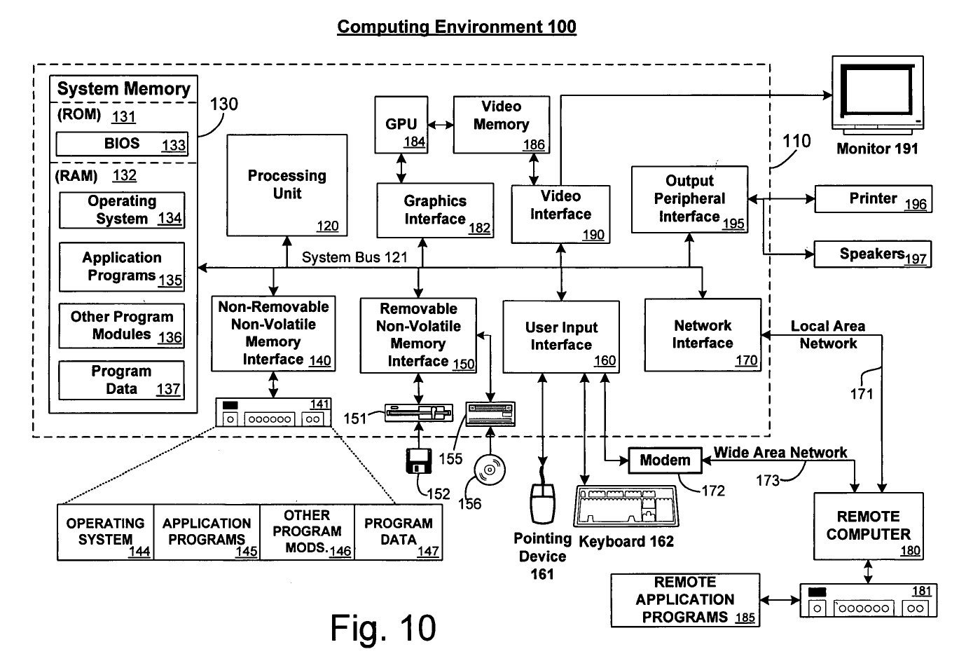

FIG. 10 and the following discussion are intended to provide a brief general description of a suitable computing device in connection with which the invention may be implemented. For example, any of the client and server computers or devices illustrated in FIG. 9 may take this form. It should be understood, however, that handheld, portable and other computing devices and computing objects of all kinds are contemplated for use in connection with the present invention, i.e., anywhere from which data may be generated, processed, received and/or transmitted in a computing environment. While a general purpose computer is described below, this is but one example, and the present invention may be implemented with a thin client having network/bus interoperability and interaction. Thus, the present invention may be implemented in an environment of networked hosted services in which very little or minimal client resources are implicated, e.g., a networked environment in which the client device serves merely as an interface to the network/bus, such as an object placed in an appliance. In essence, anywhere that data may be stored or from which data may be retrieved or transmitted to another computer is a desirable, or suitable, environment for operation of the database testing techniques of the invention.

Although not required, the invention can be implemented via an operating system, for use by a developer of services for a device or object, and/or included within application or server software that operates in accordance with the invention. Software may be described in the general context of computer-executable instructions, such as program modules, being executed by one or more computers, such as client workstations, servers or other devices. Generally, program modules include routines, programs, objects, components, data structures and the like that perform particular tasks or implement particular abstract data types. Typically, the functionality of the program modules may be combined or distributed as desired in various embodiments. Moreover, the invention may be practiced with other computer system configurations and protocols. Other well known computing systems, environments, and/or configurations that may be suitable for use with the invention include, but are not limited to, personal computers (PCs), automated teller machines, server computers, hand-held or laptop devices, multi-processor systems, microprocessor-based systems, programmable consumer electronics, network PCs, appliances, lights, environmental control elements, minicomputers, mainframe computers and the like.

FIG. 10 thus illustrates an example of a suitable computing system environment 100 in which the invention may be implemented, although as made clear above, the computing system environment 100 is only one example of a suitable computing environment and is not intended to suggest any limitation as to the scope of use or functionality of the invention. Neither should the computing environment 100 be interpreted as having any dependency or requirement relating to any one or combination of components illustrated in the exemplary operating environment 100.

With reference to FIG. 10, an exemplary system for implementing the invention includes a general purpose computing device in the form of a computer 110. Components of computer 110 may include, but are not limited to, a processing unit 120, a system memory 130, and a system bus 121 that couples various system components including the system memory to the processing unit 120. The system bus 121 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus (also known as Mezzanine bus).

Computer 110 typically includes a variety of computer readable media. Computer readable media can be any available media that can be accessed by computer 110 and includes both volatile and nonvolatile media, removable and non-removable media. By way of example, and not limitation, computer readable media may comprise computer storage media and communication media. Computer storage media include both volatile and nonvolatile, removable and non-removable media implemented in any method or technology for storage of information such as computer readable instructions, data structures, program modules or other data. Computer storage media include, but are not limited to, RAM, ROM, EEPROM, flash memory or other memory technology, CDROM, digital versatile disks (DVD) or other optical disk storage, magnetic cassettes, magnetic tape, magnetic disk storage or other magnetic storage devices, or any other medium which can be used to store the desired information and which can be accessed by computer 110. Communication media typically embody computer readable instructions, data structures, program modules or other data in a modulated data signal such as a carrier wave or other transport mechanism and include any information delivery media. The term “modulated data signal” means a signal that has one or more of its characteristics set or changed in such a manner as to encode information in the signal. By way of example, and not limitation, communication media include wired media such as a wired network or direct-wired connection, and wireless media such as acoustic, RF, infrared and other wireless media. Combinations of any of the above should also be included within the scope of computer readable media.

The system memory 130 includes computer storage media in the form of volatile and/or nonvolatile memory such as read only memory (ROM) 131 and random access memory (RAM) 132. A basic input/output system 133 (BIOS), containing the basic routines that help to transfer information between elements within computer 110, such as during start-up, is typically stored in ROM 131. RAM 132 typically contains data and/or program modules that are immediately accessible to and/or presently being operated on by processing unit 120. By way of example, and not limitation, FIG. 10 illustrates operating system 134, application programs 135, other program modules 136, and program data 137.

The computer 110 may also include other removable/non-removable, volatile/nonvolatile computer storage media. By way of example only, FIG. 10 illustrates a hard disk drive 141 that reads from or writes to non-removable, nonvolatile magnetic media, a magnetic disk drive 151 that reads from or writes to a removable, nonvolatile magnetic disk 152, and an optical disk drive 155 that reads from or writes to a removable, nonvolatile optical disk 156, such as a CD-RW, DVD-RW or other optical media. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM and the like. The hard disk drive 141 is typically connected to the system bus 121 through a non-removable memory interface such as interface 140, and magnetic disk drive 151 and optical disk drive 155 are typically connected to the system bus 121 by a removable memory interface, such as interface 150.

The drives and their associated computer storage media discussed above and illustrated in FIG. 10 provide storage of computer readable instructions, data structures, program modules and other data for the computer 110. In FIG. 10, for example, hard disk drive 141 is illustrated as storing operating system 144, application programs 145, other program modules 146 and program data 147. Note that these components can either be the same as or different from operating system 134, application programs 135, other program modules 136 and program data 137. Operating system 144, application programs 145, other program modules 146 and program data 147 are given different numbers here to illustrate that, at a minimum, they are different copies. A user may enter commands and information into the computer 110 through input devices such as a keyboard 162 and pointing device 161, such as a mouse, trackball or touch pad. Other input devices (not shown) may include a microphone, joystick, game pad, satellite dish, scanner, or the like. These and other input devices are often connected to the processing unit 120 through a user input interface 160 that is coupled to the system bus 121, but may be connected by other interface and bus structures, such as a parallel port, game port or a universal serial bus (USB). A graphics interface 182 may also be connected to the system bus 121. One or more graphics processing units (GPUs) 184 may communicate with graphics interface 182. A monitor 191 or other type of display device is also connected to the system bus 121 via an interface, such as a video interface 190, which may in turn communicate with video memory 186. In addition to monitor 191, computers may also include other peripheral output devices such as speakers 197 and printer 196, which may be connected through an output peripheral interface 195.

The computer 110 may operate in a networked or distributed environment using logical connections to one or more remote computers, such as a remote computer 180. The remote computer 180 may be a personal computer, a server, a router, a network PC, a peer device or other common network node, and typically includes many or all of the elements described above relative to the computer 110, although only a memory storage device 181 has been illustrated in FIG. 10. The logical connections depicted in FIG. 10 include a local area network (LAN) 171 and a wide area network (WAN) 173, but may also include other networks/buses. Such networking environments are commonplace in homes, offices, enterprise-wide computer networks, intranets and the Internet.

When used in a LAN networking environment, the computer 110 is connected to the LAN 171 through a network interface or adapter 170. When used in a WAN networking environment, the computer 110 typically includes a modem 172 or other means for establishing communications over the WAN 173, such as the Internet. The modem 172, which may be internal or external, may be connected to the system bus 121 via the user input interface 160, or other appropriate mechanism. In a networked environment, program modules depicted relative to the computer 110, or portions thereof, may be stored in the remote memory storage device. By way of example, and not limitation, FIG. 10 illustrates remote application programs 185 as residing on memory device 181. It will be appreciated that the network connections shown are exemplary and other means of establishing a communications link between the computers may be used.

As the foregoing illustrates, the present invention is directed to a system and method for storing and retrieving a field of an instance of a user defined type that is persisted in a database store, outside of the database store as a separate file within the file system of the computer on which the database store is implemented. The present invention is particularly advantageous for storing large data types as fields of a user defined type within a database management system. It is understood that changes may be made to the embodiments described above without departing from the broad inventive concepts thereof. For example, while an embodiment of the present invention has been described above as being implemented in Microsoft's SQL SERVER database management system, it is understood that the present invention may be embodied in any database management system that supports the creation of user defined types. Additionally, while certain aspects of the present invention have been described as being embodied in the context of the WinFS storage platform described above, it is understood that those aspects of the present invention are by no means limited to implementation in that environment. Rather, the methods and systems of the present invention can be embodied in any system in which storage and retrieval of a field of an instance of a user defined type (UDT) is desirable. Accordingly, it is understood that the present invention is not limited to the particular embodiments disclosed, but is intended to cover all modifications that are within the spirit and scope of the invention as defined by the appended claims.

What is claimed:

1. A method of testing a data store that stores and manipulates data in accordance with an object oriented programming model that provides for the designation of schemas, item types within said schemas, and attributes of said item types, said attributes having stored values, comprising:
collecting schemas stored in said data store;
for each item type in said collected schemas:
creating instances of said item types,
converting said item type instances into new user defined types (UDTs), and
storing said UDTs in said data store;
assigning values to the attributes of said UDTs at run-time; and
storing said assigned values in said data store.

2. A method as in claim 1, further comprising:
retrieving UDT values stored in said data store in said storing step; and
comparing said retrieved UDT values with values in said item type instances to verify whether or not the values in said item type instances have been stored and retrieved properly.

3. A method of testing a data store that stores and manipulates data in accordance with an object oriented programming model that provides for the designation of schemas, item types within said schemas, and attributes of said item types, said attributes having stored values, comprising:
querying schema types with specific attributes in said data store;
instantiating said schema types with said specific attributes with pre-populated attribute values;
manipulating instances of said schema types; and
verifying that the state of said instances of said schema types are as expected based on said manipulation.

4. A method as in claim 3, wherein said instantiating step comprises creating a schema information object to create a representation of said instances of said schema types.

5. A method as in claim 3, wherein said instantiating step comprises generating said pre-populated attribute values at run-time.

6. A method as in claim 3, wherein said instantiating step comprises randomly generating said pre-populated attribute values.

7. A method as in claim 3, wherein said manipulating step comprises the step of selectively inserting instances of said schema types into said data store, updating said data store to include changes to said instances of said schema types in said data store, and deleting said instances of said schema types from said data store.

8. A method as in claim 3, wherein said manipulating step comprises setting or getting attribute values and keeping track of changes to said attribute values.

9. A method as in claim 8, wherein tracking changes to said attribute values comprises tracking changes made to an instance after it has been inserted into or updated in the data store, without compile time knowledge of the attribute values of the instance.

10. A method as in claim 3, wherein said verifying step occurs at run-time.

11. A method as in claim 10, wherein said verifying step includes comparing attribute values of the instance stored in said data store with attribute values created in said instantiating step.

12. A computer readable medium comprising software for testing a data store that stores and manipulates data in accordance with an object oriented programming model that provides for the designation of schemas, item types within said schemas, and attributes of said item types, said attributes having stored values, comprising:
a first block of code that generates queries of schema types with specific attributes in said data store;
a second block of code that instantiates said schema types with said specific attributes with pre-populated attribute values;
a third block of code that manipulates instances of said schema types; and
a fourth block of code that verifies that the state of said instances of said schema types are as expected based on said manipulation.

13. A computer readable medium as in claim 12, wherein said data store comprises a WinFS data store and said object oriented programming model is WinFS.

14. A computer readable medium as in claim 12, wherein said second block of code creates a schema information object to create a representation of said instances of said schema types.

15. A computer readable medium as in claim 12, wherein said second block of code randomly generates said pre-populated attribute values at run-time.

16. A computer readable medium as in claim 12, wherein said third block of code selectively inserts instances of said schema types into said data store, updates said data store to include changes to said instances of said schema types in said data store, and deletes said instances of said schema types from said data store.

17. A computer readable medium as in claim 12, wherein said third block of code sets or gets attribute values and keeps track of changes to said attribute values.

18. A computer readable medium as in claim 17, wherein said third block of code tracks changes made to an instance after it has been inserted into or updated in the data store, without compile time knowledge of the attribute values of the instance.

19. A computer readable medium as in claim 12, wherein said fourth block of code verifies the state of said instances of said schema types at run-time.

20. A computer readable medium as in claim 19, wherein said fourth block of code compares attribute values of the instance stored in said data store with attribute values created by said second block of code.
